(19) United States
(12) Patent Application Publication
(10) Pub. No.: US 2004/0216041 A1
(43) Pub. Date: Oct. 28, 2004

(54) System and methods in interactive television and radio ratings through the internet and the telephone

(76) Inventor: Amir Ajizadeh, Sterling, VA (US)

Correspondence Address: Amir Ajizadeh, P.O. Box 650278, Sterling, VA, 20165, US

(21) Appl. No.: 10/421,755

(22) Filed: Apr. 24, 2003

(51) Int. Cl. G06F 15/00

(52) U.S. Cl. 715/513

(57) ABSTRACT

An interactive published website designed so the general television viewing public will have an opportunity to interactively submit their input on what television show they are or have just finished watching. People can log into our website and register as members. Once they are members, they can log in with us and mark the correct icons referenced to the television show they are or have just finished watching, pressing the send button will send us their input. We refer to this method as “interactive television ratings”, or ITR. ITR is a method of television and radio ratings conducted by iTvRatings.com; a website created by the inventor and polling submissions by the public through the inventor's published website. The individual polling is electronically sent to our database where it is broken down and mathematically analyzed by professional statisticians to give us a more accurate sampling of television and radio ratings.

### BACKGROUND OF THE INVENTION

1. Field of the Invention

The present invention relates to the field of television and radio ratings.

More particularly, the present invention relates to the method and techniques for quickly, efficiently and more accurately retrieving and analyze data input from members of iTvratings.com inc.

2. Description of Related Art

To create a website as a method for a television and radio ratings/polling service. We have created a website that will allow any individual within the television viewing or radio station listening service area of North America to log in and give certain information about themselves and their television viewing and radio listening habits.

Currently, there is only one company that is conducting such a statistical polling service. However they are not and have not claimed any specifications regarding interactive television and radio ratings. I am giving the ability to the television viewing and radio listening public to log into our website and tell us what television show they are or have just finished watching, and what radio show they have or are listening to.

We intend to also come up with a list of telephone numbers for the public to call as they are or have just finished watching a television show or have or are listening to a radio station.

The primary problem with our competitor's service is that they only collect data from a selected amount of households and systematically create a mathematical analysis of the U.S. public average. By taking our polling service to the public, we feel that we can make this specification more realistic for our clients and the public.

### SUMMARY OF INVENTION

An interactive published website designed so the general television viewing public will have an opportunity to interactively submit their input on what television show they are or have just finished watching. This website will serve as a Television Ratings service for the public, television networks, television network affiliates, television stations, the media, advertising agencies, advertisers, sponsors of shows, production companies and other affiliates. Anyone whom becomes a member of iTvRatings.com will have an opportunity to log into our website and have an opportunity to place their input on what television show they have or are watching at a specific date and time and whether they liked or disliked the show. By pressing the “send” button, their data input will be sent to our database warehouse where our database will break down the information from that member. This information will be broken-down as member name, address, email address, gender, age or age group and ethnicity.

iTvRatings.com is an internet based interactive television and radio ratings company where members log in and tell us, the public, television sponsors, networks and their affiliates what television show they watched and whether they liked it or not. We are a scientific polling service for the Television and media industries. Member name, address, race, age or age group will add to the making of our scientific survey measurement.

We have created a website that is open for membership to the general television viewing public. As members of iTvRatings.com Individuals or families can go to our website and input what Television show or station they are watching at a specific time of the day. Individuals or families become members of iTvRatings.com by going into our website and filling out a form that will establish them as our member. This form will ask general questions such as:

| | |
|---|---|
| Name: | (Used for identification purposes) |
| Address: | (Used for verification of U.S. residency) |
| Gender: | (Used for Gender identification and statistics) |
| Date of Birth: | (Used for age grouping purposes) |
| Ethnicity: | (Used to average out the population as whole or within a |
| | market) |
| Email Address: | (used for logon and individuality purposes) |

Email Address: (Used for login and individuality purposes)

When these individuals input their information, our database will issue them a membership ID (this could be their email address) and a password for future log-in into our website. Member's information is confidential and it is used for our internal verification purposes only. At which point, the individual member or a family as a whole member will become part of the iTvRatings.com family member. An iTvRatings.com family member will have access to our website and be able to log in with us at any given time to give us their input. They can tell us what Television show they are watching or have just finished watching by clicking on certain icons and pressing the send button. We intent to share this information (give, trade or sell this information) with television networks, television network affiliates, television stations, the media, advertising agencies, advertisers, sponsors of shows, production companies and other affiliates. The objective of this system is to create a new method for television rating.

### SUMMARY OF INVENTION (CONTINUED)

The primary problem with our competitor's service is that they only collect data from a selected amount of households and systematically create a mathematical analysis of the U.S. public average. By taking our polling service to the public, we feel that we can make this specification more realistic for our clients and the public.

### DESCRIPTION

To create a website as a method for a television and radio ratings polling service. We have created a website that will allow any individual within the television viewing service area of North America to log in and give certain information about themselves and their television viewing habits. Our website will retrieve information from the television viewers who are members of our site. We analyze this information and conduct a mathematical analysis of this polling service. This statistical overview will be averaged out in many different forms to give us an average of these results.

We may take these results and submit them publicly and/or to private industries for a profit. Our main objectives are to:

Create a new method for television and radio ratings.

Allow television viewers to give their input on their television viewing habits or their input or thoughts on what they are watching and whether they liked or disliked the show.

To create a more accurate television ratings service for the public, television networks, television network affiliates, television stations, the media, advertising agencies, advertisers, sponsors of shows, production companies and other affiliates. To generate income for the inventor and iTvRatings.com

The primary problem with our competitor's service is that they only collect data from a selected amount of households and systematically create a mathematical analysis of the U.S. public average. By taking our polling service to the public, we feel that we can make this specification more realistic for our clients and the public.

We are allowing the general public to log into our website, create a profile of who they are and vote for the show that they are or have just finished watching on television, or which radio station they are or have just finished listening to.

When these individuals input their information, our database will issue them a membership ID (this could be their email address) and a password for future log-in into our website. Member's information is confidential and it is used for our internal verification purposes only. At which point, the individual member or a family as a whole member will become part of the iTvRatings.com family member. An iTvRatings.com family member will have access to our website and be able to log in with us at any given time to give us their input. They can tell us what Television show they are watching or have just finished watching by clicking on certain icons and pressing the send button. We intent to share this information (give, trade or sell this information) with television networks, television network affiliates, television stations, the media, advertising agencies, advertisers, sponsors of shows, production companies and other affiliates. The objective of this system is to create a new method for television ratings.

What I claim as my invention is:

1. To create a website as a method for a television and radio ratings/polling service. We have created a website that will allow any individual within the television viewing or radio station listening service area of North America to log in and give certain information about themselves and their television viewing and radio listening habits.

2. In reference to claim 1, the first web page view will be structured as an introduction page whereas an individual can log into and give us certain information about them selves. In this member registration form we will require certain information such as: gender, date of birth, address, email address and ethnicity. This information inputted into our data base from the individual will help us acknowledge and confirm their existence and identify them as who they are. The first page will also give them information about us, who we are and what we do.

3. As per claim 2, we require this personal information from the individual to establish a more accurate and scientific mathematical statistic in our research regarding this television ratings/polling service. There will be icons to help direct individuals in filling out the registration forms. Once the individual has filled out this or any other forms through our website, they will press the “send” button and the information they have inputted will be sent out to our data base where it will be broken down in whole and in several different categories such as: gender, date of birth, address, email address and ethnicity. This information is crucial to us because it will tell us who this person is and which television market he/she is in. we require this information in order to use for our statistical analysis. When this information is given to us, the individual will receive an email that will tell him/her they are now members of iTvRatings.com. We will give this member a user name and password. They require this user name password to log in with us and give us their input on what show they are or have just finished watching.
We will also structure a specific web page that the member will be automatically directed to. This web page is a page designed for the member's geographical television marketing area. Every time this member logs into our site he/she will be directed there.

4. In relevance to claim 3, the new member will from that point on be able to log in at anytime and give us information regarding what television show they have watched. They do this by using their log in name and password. At this point they will see a page that will clearly identify that specific user and the user will be given choices on what they have watched. The member's choices on the screen will be as follows: the date, time of viewing or log in, the name of the television network, station or cable. The icons in front of choices can be pressed using a computer mouse. The choices will also include a button for “none” if they did not watch television at that moment. Once the choice has been selected they will be required to press the send button and the input will be sent to our data base where is will be broken down for our internal use. An icon button can also be pushed to on member's behalf to let us know whether they liked or disliked the show.

5. pursuant to claim 4, The data base will break down the information that the member has just sent to us via our website. Our data base will break down the data into different categories for our own internal use. The break down will consist of: gender, age, geographical territory (market) and ethnicity. We will utilities the information from the data base to mathematically analyze a statistical average on television viewing public. A limited amount of this information will be released to the public and a detailed information will be released to the clients. A detailed information release will consist of information regarding the gender, age, market and ethnicity of the average television viewers.

6. Clients can consist of television networks, television stations, cable companies, ad agencies, television sponsors etc. these clients will have special privileges to special website that will only they have access to. They will be able to view averages and possibly full polling totals of the voting from our members. Clients can see gender, age, market and ethnicity of the members. However, we will hold the identity of our members from them and the general public.

7. pursuant to claim 6, we plan to implement this into use for radio stations as well. Whereas, a member can log into our site and be able to tell us what radio station they are or have been listing to during a specific date and time. Whereas, our clients would be radio stations, ad agencies and their sponsors. The general idea will be the same as the television ratings services.

8. Another method of television and radio ratings will consist of issuing a specific toll free or local calling numbers whereas a viewer or listener can call the phone number that is specifically designated for a specific television show, network or station. By calling a specific phone number, by our designation, viewers or listeners will be telling us what television show they are watching or what radio station or show they were or are listening to. Although this method is none scientific, it can be added to our polling process. This method could be used for the general public who don't have access to a computer or access to a computer at that specific moment. We can make the telephone polling more scientific by giving our members a special code to input when they call the phone numbers to make their input.

9. In reference to claims 1 through 8, We plan to do this television and radio ratings/polling service at a national level, and then expand into international markets. We will use this site to add additional links for marketing purposes. We will give the member an opportunity to preview a specific television show before it is shown on television.

10. We will create chat rooms and or posted boards so members will be able to meet one another and be able to chat about anything. We will designate chat rooms for specific shows where the producers and television network executives can go into and look at what people are saying about their shows.

11. An interactive published website designed so the general television viewing public will have an opportunity to interactively submit their input on what television show they are or have just finished watching. This website will serve as a Television Ratings service for the public, television networks, television network affiliates, television stations, the media, advertising agencies, advertisers, sponsors of shows, production companies and other affiliates. Anyone whom becomes a member of iTvRatings.com will have an opportunity to log into our website and have an opportunity to place their input on what television show they have or are watching at a specific date and time and whether they liked or disliked the show. By pressing the “send” button, their data input will be sent to our database warehouse where our database will break down the information from that member. This information will be broken-down as member name, address, email address, gender, age or age group and ethnicity.

12. iTvRatings.com is an internet based interactive television and radio ratings company where members log in and tell us, the public, television sponsors, networks and their affiliates what television show they watched and whether they liked it or not. We are a scientific polling service for the Television and media industries. Member name, address, race, age or age group will add to the making of our scientific survey measurement.

13. We have created a website that is open for membership to the general television viewing public. As members of iTvRatings.com Individuals or families can go to our website and input what Television show or station they are watching at a specific time of the day. Individuals or families become members of iTvRatings.com by going into our website and filling out a form that will establish them as our member. This form will ask general questions such as:

| | |
|---|---|
| Name: | (Used for identification purposes) |
| Address: | (Used for verification of U.S. residency) |
| Gender: | (Used for Gender identification and statistics) |
| Date of Birth: | (Used for age grouping purposes) |
| Ethnicity: | (Used to average out the population as whole or within a |
| | market) |
| Email Address: | (Used for login and individuality purposes) |

Email Address: (Used for login and individuality purposes)

14. When these individuals input their information, our database will issue them a membership ID (this could be their email address) and a password for future log-in into our website. Member's information is confidential and it is used for our internal verification purposes only. At which point, the individual member or a family as a whole member will become part of the iTvRatings.com family member. An iTvRatings.com family member will have access to our website and be able to log in with us at any given time to give us their input. They can tell us what Television show they are watching or have just finished watching by clicking on certain icons and pressing the send button. We intent to share this information (give, trade or sell this information) with television networks, television network affiliates, television stations, the media, advertising agencies, advertisers, sponsors of shows, production companies and other affiliates. The objective of this system is to create a new method for television rating.

15. To create a website as a method for a television and radio ratings polling service. We have created a website that will allow any individual within the television viewing service area of North America to log in and give certain information about themselves and their television viewing habits. Our website will retrieve information from the television viewers who are members of our site. We analyze this information and conduct a mathematical analysis of this polling service. This statistical overview will be averaged out in many different forms to give us an average of these results.
